(19) United States
(12) Patent Application Publication
(10) Pub. No.: US 2022/0256095 A1
(43) Pub. Date: Aug. 11, 2022

(54) DOCUMENT IMAGE CAPTURING DEVICE AND CONTROL METHOD THEREOF

(71) Applicant: Aver Information Inc., New Taipei City (TW)

(72) Inventors: Wei-Chih Lin, New Taipei City (TW); Yun-Long Sie, New Taipei City (TW)

(21) Appl. No.: 17/575,678

(22) Filed: Jan. 14, 2022

(30) Foreign Application Priority Data
Feb. 9, 2021 (TW) 110104953

(51) Int. Cl. H04N 5/232; G06F 3/01

(52) U.S. Cl. CPC H04N 5/232939; G06F 3/017

(57) ABSTRACT

A control method of a document image capturing device cooperates with a storage unit. The control method includes an image capturing process, a default image detection process, a command judgment process, and an operation execution process. The image capturing process being to continuously capture an image. The default image detection process being to generate a recognition image when the image contains a default image. The command judgment process being to obtain a first feature command and a second feature command in accordance with the recognition image. The first feature command being corresponding to a specific block address of storage blocks of the storage unit, and the second feature command being corresponding to a control command. The operation execution process being to perform operations on the storage block of the specific block address of the storage unit according to the first feature command and the second feature command.

### CROSS REFERENCE TO RELATED APPLICATIONS

This Non-provisional application claims priority under 35 U.S.C. § 119(a) on Patent Application No. 110104953 filed in Republic of China on Feb. 9, 2021, the entire contents of which are hereby incorporated by reference.

### BACKGROUND

### 1. Technical Field

The present invention relates a document image capturing device and control method thereof, and particularly relates to a document image capturing device and control method thereof which can simplify the operation procedure.

### 2. Description of Related Art

A document camera captures a planar or three-dimensional (3D) image of a subject through a lens and an adjustable mechanical structure, and then displays the digital image of the subject through a display device to viewers. The document camera can not only display the image of the subject in real time, but also store the image of the subject for subsequent display to different viewers.

As more and more images are stored, it will be more and more difficult for users to select the desired image. It is difficult to operate intuitively because it is necessary to select one by one among the numerous images, which will limit the operational fluency.

In general, when operating the document camera, the user must adjust the focal length or zoom in and zoom out of the document camera according to the size of the subject and the distance between the subject and the lens to obtain a clear image. For example, when the user wants to display a model car, a flower, a mobile phone, and a mug in order, it means that the user must arrange the model car, flower, mobile phone, mug in order, and adjust focus, zoom in or zoom out after each arrangement. If the user needs to display the flower again after displaying the mug, the flower must be rearranged and the focus, zoom in, and zoom out of the lens must be readjusted. As a result, when there are multiple subjects that need to be frequently displayed, it will cause the user to have to repeatedly arrange and adjust, which will cause time consumption and inconvenience in use.

Therefore, it is one of the important subject matters to provide a control device and a control method of a document image capturing device so that the user can easily remember and can easily switch the image.

### SUMMARY OF THE INVENTION

In view of the foregoing, the purpose of the invention is to provide a document image capturing device and a control method thereof that can save the operation time on the document image capturing device and simplify the operation process.

To achieve the above, a control method of a document image capturing device of the invention is applied in conjunction with a storage unit, wherein the storage unit has a plurality of storage blocks. The control method includes an image capturing process, a default image detection process, a command judgment process, and an operation execution process. The image capturing process is to continuously capture an image. The default image detection process is to generate a recognition image when the image contains a default image. The command judgment process is to obtain a first feature command and a second feature command based on the recognition image, where the first feature command corresponds to a specific block address of the storage blocks of the storage unit, and the second feature command corresponds to a control command. The operation execution process is to perform operations on the storage block of the storage unit corresponding to of the specific block address based on the first feature command and the second feature command.

In one embodiment, the image captured by the image capturing process contains a subject image.

In one embodiment, the operation execution process further includes a storing process and an extracting process. The storing process is to store the subject image into the storage block of the storage unit corresponding to the specific block address based on the first feature command and the second feature command. The extracting process is to read the subject image stored in the storage block of the storage unit corresponding to the specific block address based on the first feature command and the second feature command.

In one embodiment, the control command includes a write command and a read command.

In one embodiment, the default image is a gesture image, and the command judgment process further includes extracting a first part of the gesture image to generate the first feature command accordingly and extracting a second part of the gesture image to generate the second feature command accordingly.

In one embodiment, the first part of the gesture image contains the location and number of fingers, while the second part of the gesture image contains texture features.

In one embodiment, the control method further includes an output process, which outputs the subject image to a display device.

In addition, to achieve the above, a document image capturing device, which includes an image capturing unit, an arithmetic unit, a storage unit, and a control unit. The image capturing unit is to capture an image. The storage unit has a plurality of storage blocks, and each block has a specific block address. The arithmetic unit is coupled with the image capturing unit. When a default image is detected in the image, a recognition image is generated, and a first feature command and a second feature command are generated according to the recognition image, where the first feature command associates with the specific block address of the storage blocks of the storage unit, and the second feature command associates with a control command. The control unit is respectively coupled with the arithmetic unit and the storage unit and performs operations on the storage block of the specific block address of the storage unit according to the first feature command and the second feature command.

In one embodiment, the control unit can store the subject image in the storage block of the storage unit corresponding to the specific block address based on the first feature command and the second feature command. In addition, the control unit can also read the subject image stored in the storage block of the storage unit corresponding to the specific block address based on the first feature command and the second feature command.

In one embodiment, the document image capturing device further includes an output unit, which is coupled with the storage unit and outputs the subject image to a display device.

As mentioned above, a document image capturing device and control method thereof of the invention can generate at least two feature commands through one default image and use the feature commands to perform corresponding operations on the storage unit of the document image capturing device. Accordingly, the operation time can be saved, and the complexity of the operation can also be simplified.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a block diagram showing the document image capturing device according to a preferred embodiment of the present invention.

FIG. 2 is a schematic diagram showing the storage unit of the document image capturing device.

FIG. 3 is a flow chart showing the control method of the document image capturing device according to a preferred embodiment of the present invention.

FIG. 4A to FIG. 4C are schematic diagrams showing gestures corresponding to the different storage blocks.

FIG. 5A and FIG. 5B are schematic diagrams showing gestures corresponding to the different control commands.

FIG. 6A is a schematic diagram showing the image captured by the image capturing unit of the document image capturing device in the target area.

FIG. 6B to FIG. 6D are schematic diagrams showing the simultaneous appearance of the subject and gesture in the target area.

FIG. 7 is a schematic diagram showing that only gesture appears in the target area.

### DETAILED DESCRIPTION

The following disclosures, with reference to corresponding figures, provide detail descriptions for preferable embodiments of the pairing and interconnecting method for electronic devices in the present invention. Furthermore, reference will be made to the drawings to describe various inventive embodiments of the present disclosure in detail, wherein like numerals refer to like elements throughout.

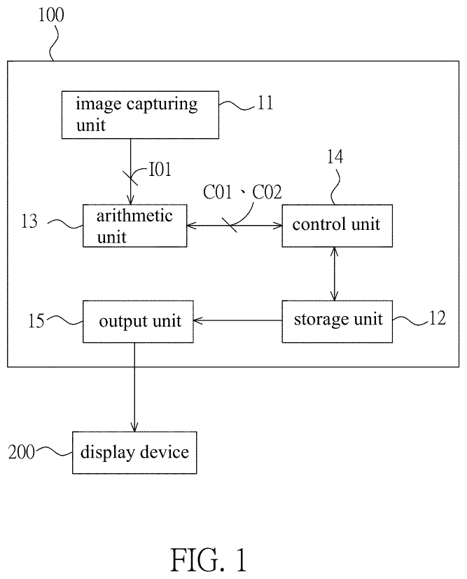

Please refer to FIG. 1, a document image capturing device 100 according to a preferred embodiment of the invention includes an image capturing unit 11, a storage unit 12, an arithmetic unit 13, a control unit 14, and an output unit 15. Among them, the arithmetic unit 13 is coupled to the image capturing unit 11, the control unit 14 is coupled to the arithmetic unit 13 and the storage unit 12, and the output unit 15 is coupled to the storage unit 12. In addition, the output unit 15 can also be coupled to a display device 200 to output images to the display device 200 and display it. Here, the so-called “couple, coupled, or coupling” may include an electrical connection through a transmission line, or a communication connection established through wireless transmission, and this definition will also apply to the subsequent description. In addition, the display device 200 may include, but is not limited to, a liquid crystal display, an LED display, or a projector.

The image capturing unit 11 continuously captures images of a target area. Therefore, the user can place the object to be captured in the target area so that the image capturing unit 11 can capture the subject image 101. Under normal operation, the subject image I01 captured by the image capturing unit 11 is finally directly output by the output unit 15 to the display device 200.

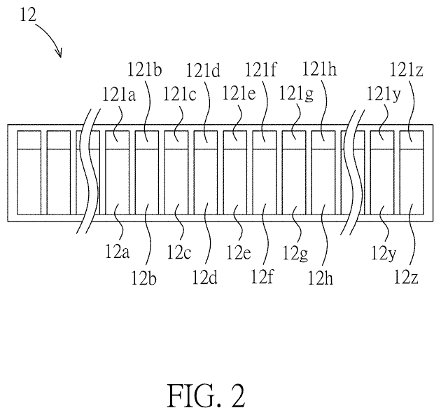

Please refer to FIG. 1 and FIG. 2, the storage unit 12 has a plurality of storage blocks 12a˜12z, and each block has a specific block address 121a˜121z. The storage unit 12 includes but is not limited to hard drives, solid state drives, flash memory and combinations thereof. In short, the storage unit 12 referred to here is not limited to a single unit, but generally refers to all units in the document image capturing device 100 that can store electrical signals. Among them, the storage unit 12 may include temporary memory, rewritable memory, erasable memory, etc., which is not limited here. For example, the aforementioned image captured by the image capturing unit 11 can be stored in the temporary memory as a buffer and then output by the output unit 15 (not shown in the figure).

Please refer to FIG. 1 again, the arithmetic unit 13 receives the subject image I01 captured by the image capturing unit 11 and analyzes the content of the subject image I01. When the arithmetic unit 13 detects that the subject image I01 contains a default image thereby generates a recognition image for the default image. Then, a first feature command C01 and a second feature command C02 are obtained based on the recognition image. Here, the default image can be preset by the system or defined by the user. In the embodiment, the default image includes a plurality of gestures, and the first feature command C01 and the second feature command C02 correspond to the different gesture characteristics. The first feature command C01 corresponds to the specific block address 121a˜121z of the storage blocks 12a˜12z of the storage unit 12 and the second feature command C02 corresponds to a control command. Among them, the control command is, for example, a write command or a read command.

The control unit 14 performs operations on the storage blocks 12a˜12z of the storage unit 12 corresponding to the specific block addresses 121a˜121z according to the first feature command C01 and the second feature command C02. Here, the so- called “operation” may include, but is not limited to, writing or reading the storage blocks 12a˜12z corresponding to the specific block addresses 121a˜12z. To further explain, the control unit 14 can write (i.e. store) the subject image I01 in the storage block 12a˜12z corresponding to the specific block address 121a˜121z based on the first feature command C01 and the second feature command C02. The control unit 14 can also read the subject image 101 stored in the storage block 12a˜12z corresponding to the specific block address 121a˜121z based on the first feature command C01 and the second feature command C02. It is to be noted that images stored in the storage block 12a˜12z corresponding to the specific block address 121a˜121z is not limited to the subject image I01 and can also be the image preset by the system or the image stored separately by the user.

The output unit 15 can output the subject image I01 continuously captured by the image capturing unit 11 to the display device 200 and can also output the images (including the subject image 101) stored in storage block 12a˜12z of the storage unit 12 corresponding to the specific block address 121a˜121z to the display device 200 by the control unit 14.

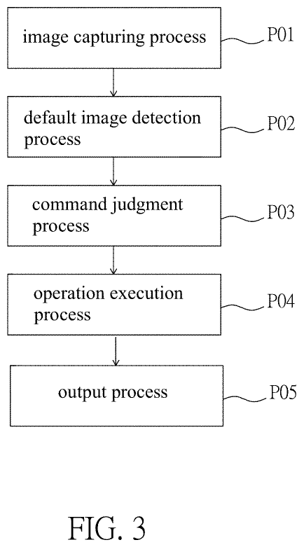

Please refer to the above description and FIG. 3 to illustrate a control method of a document image capturing device according to a preferred embodiment of the invention. The control method includes an image capturing process P01, a default image detection process P02, a command judgment process P03, an operation execution process P04, and an output process P05.

During the image capturing process P01, the image capturing unit 11 is to continuously capture images of the target area. Here, the so-called “continuously capture image” may include a video that is a continuous image, or an image composed of a plurality of single-frame images with a time interval, which is not limited here.

The default image detection process P02 is to generate a recognition image when the image captured by the image capturing unit 11 contains a default image. In the embodiment, it is possible to continuously or periodically detect (or determine) whether the image captured by the image capturing unit 11 includes the default image. The default image is, for example, a gesture, so when the gesture is detected in the image, the recognition image corresponding to the gesture will be generated. Among them, the default image can be preset by the system or defined by the user.

The command judgment process P03 is to obtain the first feature command C01 and the second feature command C02 based on the recognition image. Among them, the first feature command C01 corresponds to the specific block addresses 121a˜121z of the storage blocks 12a˜12z of the storage unit 12, and the second feature command C02 corresponds to a control command. In the embodiment, the first feature command C01 may be information obtained from the analysis of the position and number of the fingers in the gesture, and the second feature command C02 may be information obtained from the analysis of the texture features of the hand included in the gesture.

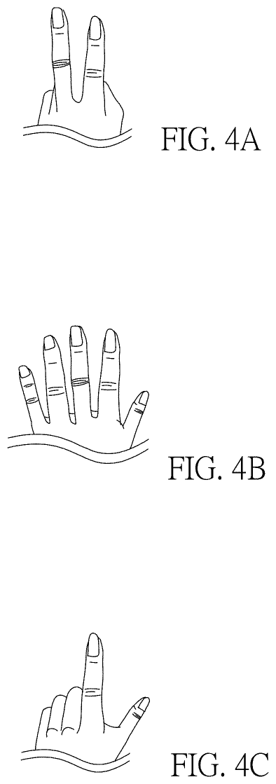

For the analysis of the first feature command C01, please refer to FIGS. 4A to 4C, where the gesture in FIG. 4A may correspond to the second specific block address 121b of the second storage block 12b; the gesture in FIG. 4B may correspond to the fifth specific block address 121e of the fifth storage block 12e; the gesture in FIG. 4C may correspond to the seventh specific block address 121g of the seventh storage block 12g. The above is only an example and not a limitation. The correspondence between the gesture and the storage block can be changed arbitrarily in the spirit of the present invention.

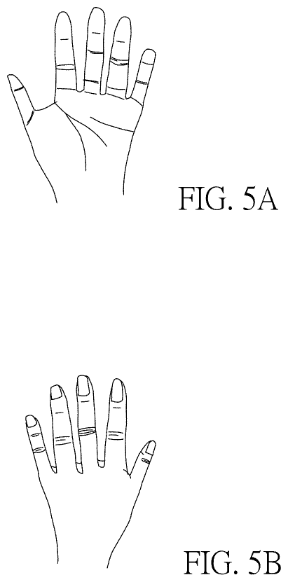

For the analysis of the second feature command C02, please refer to FIGS. 5A and 5B. FIG. 5A is a schematic diagram showing the palm facing upwards that there are more and complex texture lines in the finger and the palm, such as fingerprints and palmprints. FIG. 5B is a schematic diagram showing the palm facing downwards that due to the nails in the finger part, the texture lines are relatively simple, and the texture lines of the dorsum manus are much smoother than those of the palm. Through the texture feature analysis of the finger part and the palm part, it can be determined that the gesture of the recognition image is the palm or the dorsum manus. In the embodiment, when the judgment result is the palm, it means the control command is a read command, and when the judgment result is the dorsum manus, it means the control command is a write command. In another embodiment, the key point coordinate analysis of the hand can also be used to determine that the gesture of the recognition image is the palm or the dorsum manus, for example, by using machine learning or neural network analysis to analyze the key points of the bones of the hand and determine that the gesture of the recognition image is the palm or the dorsum manus based on the position of the thumb, which is not limited here.

As mentioned above, the control method can obtain the first feature command and the second feature command from the single gesture image. In short, the complex control can be completed by the simple gestures. To further illustrate, the command judgment process P03 also includes extracting a first part of the gesture image thereby generate the first feature command and extracting a second part of the gesture image thereby generate the second feature command. The so-called “first part of the gesture image” is the distribution position and number of the finger, and “the second part of the gesture image” is the texture feature of the finger part and the palm part.

The operation execution process PO4 is to perform operations on the storage block 12a˜12z of the storage unit 12 corresponding to the specific block addresses 121a˜121z based on the first feature command C01 and the second feature command C02. Since the first feature command C01 corresponds to the specific block address 121a˜121z of the storage block 12a˜12z of the storage unit 12, and the second feature command C02 corresponds to a write command or a read command. Therefore, the result of integrating the first feature command C01 and the second feature command C02 at least includes writing the subject image to the storage block corresponding to the specific block address or reading images from the storage block corresponding to the specific block address.

The output process P05 is to output the image read from the storage block corresponding to the specific block address to the display device 200. On the other hand, when no specific commands are executed, the output process P05 continuously outputs the images captured by the image capturing unit 11 on the target area.

In order to make the invention clearer, the following is an example to illustrate the control method of the document image capturing device. The scenario of the example is that the user displays a newspaper clipping 31, a first model car 32, and a second model car 33 in sequence, and wants to store the image of the newspaper clipping 31 into the first storage block 12a of the storage unit 12, store the image of the first model car 32 into the second storage block 12b of the storage unit 12, and store the image of the second model car 33 into the fifth storage block 12e of the storage unit 12.

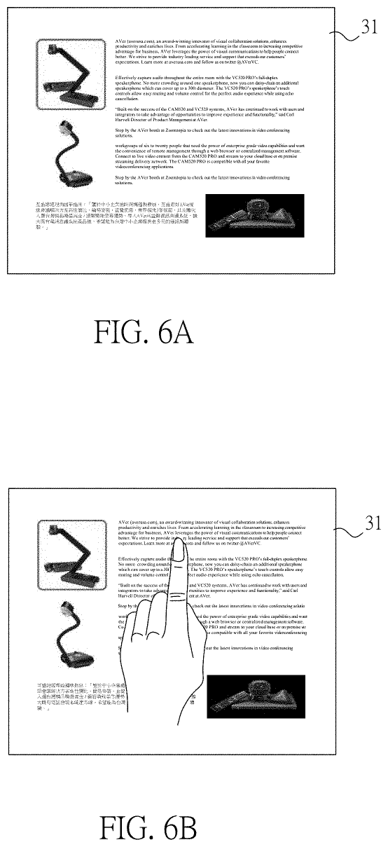

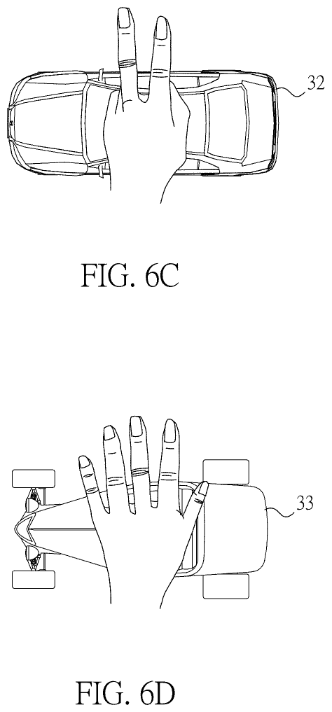

First, as shown in FIG. 6A, the user places the newspaper clipping 31 in the target area of the document image capturing device 100 to capture the image of the newspaper clipping 31 through the image capturing unit 11 of the document image capturing device 100 to generate the subject image and output the subject image to the display device 200 through the output unit 15 of the document image capturing device 100 for viewers.

Then, as shown in FIG. 6B, the user can show the dorsum manus upward and one-finger gesture in the target area of the document image capturing device 100. At this time, the image captured by the image capturing unit 11 will contain the one-finger gesture, so the arithmetic unit will generate the recognition image corresponding to the one-finger gesture, and further analyze the recognition image to obtain the first feature command C01 and the second feature command C02. The specific block address 121a corresponding to the first storage block 12a of the storage unit 12 can be obtained from the one-finger gesture, and the write command can be obtained by judging the dorsum manus is upward (i.e. the palm is downward) and nails. According to the first feature command C01 and the second feature command C02, it can be obtained that the user wants to write the subject image in the target area into the first storage block 12a. Then, the document image capturing device 100 will display a prompt message for capturing the image to inform the user, and then the subject image will be stored in the first storage block 12a.

Then, the user removes the newspaper clipping 31 from the target area, and as shown in FIG. 6C, the user then places the first model car 32 in the target area of the document image capturing device 100 to capture the image of the first model car 32 through the image capturing unit 11 of the document image capturing device 100 to generate the subject image and output the subject image to the display device 200 through the output unit 15 of the document image capturing device 100 for viewers. Then, the user shows the dorsum manus upward and two-finger gestures in the target area of the document image capturing device 100. At this time, the image captured by the image capturing unit 11 will contain the two-finger gesture, so the arithmetic unit 13 will generate the corresponding recognition image based on the two-finger gesture, and further analyze the recognition image to obtain the first feature command C01 and the second feature command C02. The second specific block address 121b corresponding to the second storage block 12b of the storage unit 12 can be obtained from the two-finger gesture, and the write command can be obtained by judging the dorsum manus is upward (i.e. the palm is downward) and nails. According to the first feature command C01 and the second feature command C02, it can be obtained that the user wants to write the subject image in the target area into the second storage block 12b. Then, the document image capturing device 100 will display a prompt message for capturing the image to inform the user, and then the subject image will be stored in the second storage block 12b.

Then, the user removes the first model car 32 from the target area, and as shown in FIG. 6D, the user then places the second model car 33 in the target area of the document image capturing device 100 to capture the image of the second model car 33 through the image capturing unit 11 of the document image capturing device 100 to generate the subject image and output the subject image to the display device 200 through the output unit 15 of the document image capturing device 100 for viewers. Then, the user shows the dorsum manus upward and five-finger gesture in the target area of the document image capturing device 100. At this time, the image captured by the image capturing unit 11 will contain the five-finger gesture, so the arithmetic unit 13 will generate the corresponding recognition image based on the five-finger gesture, and further analyze the recognition image to obtain the first feature command C01 and the second feature command C02. The fifth specific block address 121e corresponding to the fifth storage block 12e of the storage unit 12 can be obtained from the five-finger gesture, and the write command can be obtained by judging the dorsum manus is upward (i.e. the palm is downward) and nails. According to the first feature command C01 and the second feature command C02, it can be obtained that the user wants to write the subject image in the target area into the fifth storage block 12e. Then, the document image capturing device 100 will display a prompt message for capturing the image to inform the user, and then the subject image will be stored in the fifth storage block 12e.

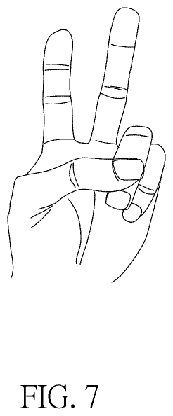

At this point, when the user needs to show the first model car 32 again, as shown in FIG. 7, the user can show the palm up and the two-finger gestures in the target area so that the gesture image will be captured by the image capturing unit 11. Then the arithmetic unit 13 will generate the recognition image corresponding to the gesture, and further analyze the recognition image to obtain the first feature command C01 and the second feature command C02. The second specific block address 121b corresponding to the second storage block 12b of the storage unit 12 can be obtained from the two- finger gesture, and the read command can be obtained by judging the palm is upwards based on the characteristics of the finger, the texture of the palm, or the location of the nails. According to the first feature command C01 and the second feature command C02, it can be obtained that that the user wants to read the stored image from the second storage block 12b. Then, the document image capturing device 100 will display a prompt message for switching the image to inform the user, and then immediately output the image stored in the second storage block 12b.

It is to be noted that in the above reading example, if no image is stored in the corresponding storage block, the document image capturing device 100 can issue a corresponding prompt message or perform no action.

In summary, a document image capturing device and control method thereof of the invention can generate at least two feature commands through one default image and use the feature commands to perform corresponding operations on the storage unit of the document image capturing device. Accordingly, the operation time can be saved, and the complexity of the operation can also be simplified. Furthermore, the present invention utilizes one gesture to generate characteristic commands corresponding to the storage block of the storage unit and generates the control command corresponding to writing or reading, so that simple gestures can be used to generate complex commands, thus users can conveniently operate the document image capturing device.

The foregoing descriptions for all embodiment as disclosed are merely for exemplary and explanatory purposes but are not intended to limit or depart from the scope and spirit of the present invention. Any change or modification to the foregoing descriptions and embodiments which still maintain their equivalents, should all be enclosed or covered by the scope of the appended claims.

What is claimed is:

1. a control method of a document image capturing device, which is applied in conjunction with a storage unit having a plurality of storage blocks, comprising:
an image capturing process, which is continuously capturing an image;
a default image detection process, which is generating a recognition image when the image contains a default image;
a command judgment process, which is obtaining a first feature command and a second feature command based on the recognition image, wherein the first feature command corresponds to a specific block address of the storage blocks of the storage unit, and the second feature command corresponds to a control command; and
an operation execution process, which is performing operations on the storage block of the storage unit corresponding to of the specific block address based on the first feature command and the second feature command.

2. The control method of the document image capturing device of claim 1, wherein the image captured by the image capturing process contains a subject image.

3. The control method of the document image capturing device of claim 2, wherein the operation execution process further comprising:
a storing process, which is storing the subject image into the storage block of the storage unit corresponding to the specific block address based on the first feature command and the second feature command; and
an extracting process, which is reading the subject image stored in the storage block of the storage unit corresponding to the specific block address based on the first feature command and the second feature command.

4. The control method of the document image capturing device of claim 1, wherein the control command comprises a write command and a read command.

5. The control method of the document image capturing device of claim 1, wherein the default image is a gesture image, and the command judgment process further comprising:
extracting a first part of the gesture image to generate the first feature command accordingly; and
extracting a second part of the gesture image to generate the second feature command accordingly.

6. The control method of the document image capturing device of claim 5, wherein the first part of the gesture image comprises the number of fingers, while the second part of the gesture image comprises texture features.

7. The control method of the document image capturing device of claim 2, further comprising:
an output process, which is outputting the subject image to a display device.

8. a document image capturing device, comprising:
an image capturing unit, which is capturing an image;
a storage unit, which has a plurality of storage blocks, and each block has a specific block address;
an arithmetic unit, which is coupling with the image capturing unit, generating a recognition image when a default image is detected in the image, and generating a first feature command and a second feature command according to the recognition image, wherein the first feature command is associated with the specific block address of the storage blocks of the storage unit, and the second feature command is associated with a control command; and
a control unit, which is coupled with the arithmetic unit and the storage unit, respectively and performs operations on the storage block of the specific block address of the storage unit according to the first feature command and the second feature command.

9. The document image capturing device of claim 8, wherein the image is a subject image.

10. The document image capturing device of claim 9, wherein the control unit stores the subject image into the storage block of the storage unit corresponding to the specific block address based on the first feature command and the second feature command or reads the subject image stored in the storage block of the storage unit corresponding to the specific block address based on the first feature command and the second feature command.

11. The document image capturing device of claim 8, wherein the default image is a gesture image.

12. The document image capturing device of claim 9, further comprising:
an output unit, which is coupled with the storage unit and outputs the subject image to a display device.
